(19) United States
(12) Patent Application Publication
(10) Pub. No.: US 2006/0221066 A1
(43) Pub. Date: Oct. 5, 2006

(54) Touch screen data control device

(76) Inventor: Ronald F. Cascella, Rocklin, CA (US)

Correspondence Address: Pamela W. Bertani;weintraub genshlea chediak, 11th Floor, 400 Capitol Mall, Sacramento, CA, 95814, US

(21) Appl. No.: 11/271,091

(22) Filed: Nov. 10, 2005

Related U.S. Application Data
(60) Provisional application No. 60/667,398, filed on Apr. 4, 2005.
(60) Provisional application No. 60/679,024, filed on May 9, 2005.

(51) Int. Cl. G09G 5/00

(52) U.S. Cl. 345/179

(57) ABSTRACT

The present invention is a hands-free touch screen data control device for use in conjunction with electronic data storage equipment, which allows a screen operator to operatively engage a touch screen and enter or manipulate data without the necessity of holding or gripping the touch screen device; removing the touch screen device for free use of a screen operator's corresponding hand; or retrieving the touch screen device from its “parked” or stored location for continued use. The present invention obviates the need for an operator to remove or otherwise reposition the touch screen device in order have a full range of utility of the device-engaged hand while the touch screen device remains securely in place. Consequently, the present invention maximizes efficiency and productivity in high frequency data manipulation scenarios, and is used comfortably and effectively with respect to personal data management.

### CROSS-REFERENCE TO RELATED APPLICATION

The present application claims the benefit of U.S. provisional application No. 60/667,398 filed Apr. 4, 2005, and U.S. provisional application Ser. No. 60/679,024 filed May 9, 2005, entitled Finger Stylus, which are incorporated by reference herein.

### BACKGROUND OF THE INVENTION

1. Field of the Invention

The present invention relates generally to a touch screen data control device for use with computer generated keyboard screens associated with electronic data devices, including pocket personal computers, (Pocket PCs), personal digital assistants (PDAs), Smartphones, stationary electronic devices, and the like. The present invention may be utilized for operating machines, gaming devices, and other electronic equipment in a wide variety of applications employing a computer touch screen.

2. Description of the Related Art

In an increasing number of applications, electronic data devices are used to store and manage data regarding any number of inanimate objects. From warehousing and inventorying items, to data tracking applications involving product transport and delivery, it is abundantly clear that the use of electronic devices in these and numerous other scenarios has become, and will likely remain, the norm in commerce and industry, as well as with respect to personal data management.

For the sake of convenience, mobility, and practical utility, electronic devices typically include a computer-generated touch screen, in place of a stand-alone keyboard, to permit an operator to enter and manage data electronically. Typically, sensing controls or softkeys are presented to the operator on the touch screen, which permit the input of information or data commands, and likewise permit the device to receive and organize data, as well as execute corresponding commands.

Two stylus models are commonly used in conjunction with electronic devices to engage touch screens, and thereby effectuate data entry and manipulation. Both models are of significantly limited utility, due to the fact that both are cumbersome to use, awkward to store and retrieve between use, and functionally inhibit an operator from simultaneously using the stylus-engaged hand for purposes other than data entry and manipulation while the stylus is not in use.

For instance, most commercially available hand-held electronic devices are designed with a pencil-shaped stylus, which an operator uses to engage a touch screen for entering and manipulating data. When the pencil-shaped stylus is not in use, an operator must place or “park” the stylus in a location until use is resumed in order to have a full range of utility for the corresponding hand. As can be imagined, and perhaps as has personally been experienced, the necessity of parking the stylus is fraught with functional disadvantages. An operator may misplace the pencil-shaped stylus, or drop it during use, and experiences difficulty in utilizing the pencil-shaped stylus simultaneously with holding or handling another item. Such circumstances result in inefficiency and diminished productivity, particularly in situations such as inventorying or warehousing items, which involve high-volume item management and corresponding data entry or manipulation.

An alternative stylus model is positioned directly on an operator's finger for engaging a touch screen to enter and manipulate data electronically. These finger-engaged stylus models, like the pencil-shaped stylus, are cumbersome in practical application and perhaps even more difficult in actual use. U.S. Pat. Nos. 6,225,988 and 6,320,570 illustrate such a device. The device disclosed is an article to be worn on the tip of an operator's finger as a stylus. The device includes a partially rigid base that encircles the finger, and a removable rigid tip that projects forwardly from the base to contact a touch screen. The base may include a core of bendable metal and a flexible rubber-like material surrounding the core. The tip is not only removable but is also interchangeable depending upon an operator's preference. A hook extends downwardly and back from the tip to engage the underside of an operator's fingertip, ideally to retain the stylus device on the operator's fingertip.

Companion U.S. Pat. Nos. 6,533,480 and 6,626,598 disclose an adjustable finger stylus to be worn on the tip of a user's finger. The stylus includes a longitudinal element, which is parallel to and in contact with the underside of the finger, which curves upwardly to terminate at the fingernail. The longitudinal element includes at least one adjustable finger engaging element, ideally to secure the stylus on the finger. The stylus also includes a tapered writing extension extending longitudinally from the end of the curved element and forward the fingernail.

U.S. design Pat. No. 440,570 discloses an adjustable finger stylus, which is virtually identical in appearance to the adjustable finger stylus of the '480 and '598 patents, respectively.

Likewise, U.S. design Pat. No. 418,494 discloses a fingertip stylus, which is virtually identical in appearance to the stylus disclosed in the '988 patent.

The shortcomings of the existing fingertip stylus devices described above are apparent. Most importantly, these fingertip stylus devices can become dislodged from an operator's finger and forever lost, particularly in high-volume data entry or data manipulation uses, such as warehousing, inventorying, item tracking and the like. U.S. Pat. Nos. 6,533,480 and 6,626,598 concede this point, and characterize each disclosed stylus as an inexpensive and easily accessible “replacement stylus” for those that are lost, which allows a user to “own several and carry one or more for convenience.”

Moreover, high frequency use of any one of the fingertip stylus models described above can cause the stylus to disengage partially from its desired position, requiring an operator to continually reposition and adjust the fingertip stylus during use. Similarly, the fingertip stylus models described above may completely or partially disengage if an operator attempts to handle, manipulate or transport other items with the fingertip stylus in place. Here, again, the stylus may become forever lost or misplaced as it disengages from an operator's finger under such circumstances.

The frustration, inconvenience and inefficiency associated with using and maintaining the above-described stylus models demonstrate that a need exists for a stylus that facilitates high frequency data entry without the need for constantly repositioning the stylus; diminishes the likelihood of the stylus becoming disengaged or lost during use; and does not impair an operator's ability to handle other objects while the stylus remains firmly in place. A need also exists for a universally fitted, functionally stable stylus that is less prone to being lost or misplaced during and between use.

### SUMMARY OF THE INVENTION

The touch screen data control device of the present invention includes two embodiments: a glove version and a finger version. Both include a stylus housing, and a stylus component fixedly attached to the stylus housing for engaging an electronic device. The gloved stylus housing fits over an operator's hand, whereas the sleeved stylus housing securely fits over the length of an operator's single finger, and is secured to the engaged finger via a radially disposed attachment means distally located from the operator's fingertip. The attachment means is typically composed of elastic or other conventionally available materials demonstrating the basic properties of elasticity, flexibility, expandability and retractability. The stylus component of the inventive device is inserted through, and fixedly attached to a stylus housing. The stylus component is attached to the stylus housing via conventional means, such as glue or other appropriately adhesive materials.

The inventive touch screen data control device may be used in conjunction with a companion glove, having an attachment means for docking a hand-held portable electron device on an operator's opposite hand. The docking attachment means may include Velcro, double-sided adhesive tape, or a variety of other suitable attachment means.

The present invention allows a screen operator to operatively engage a touch screen and enter or manipulate data without the necessity of holding or gripping the touch screen device; removing the touch screen device for free use of the screen, operator's corresponding hand; or retrieving the touch screen device from its parked location for continued use. Rather, a screen operator employing the present invention can position the invention on an operative hand comfortably and securely for sustained periods of time if desirable, and operatively engage a touch screen to input or otherwise manipulate data. Simultaneously, an operator is capable of employing the operative hand for uses other than engaging a touch screen, such as picking up inventory items, answering a telephone, or transporting an item from one location to another. The present invention obviates the need for an operator to remove, park, or otherwise reposition the touch screen device in order have a full range of utility of the device-engaged hand while the touch screen device remains securely in place.

Moreover, the inventive touch screen device is securely fitted to an operator's entire hand, or alternatively the entire length of an operator's finger—as opposed to an operator's fingertip. Consequently, the touch screen device of the present invention is superior to the existing devices, particularly because the inventive device will remain securely in place, even during high frequency use, and is far less likely to disengage and require repositioning even in high-volume data entry uses.

### BRIEF DESCRIPTION OF THE DRAWINGS

FIG. 1 is a perspective view of the touch screen data control device employing a gloved stylus housing.

FIG. 2 is a perspective view of the touch screen data control device employing a gloved stylus housing and depicting an exploded view of the internally positioned stylus component, which in use operatively contacts with an operator's fingertip.

FIG. 3 is a perspective view of the touch screen data control device employing a sleeved stylus housing.

FIG. 4 is a perspective front view of the stylus component of the touch screen data control device.

FIG. 5 is a perspective left side view of the stylus component of the touch screen data control device.

### DETAILED DESCRIPTION OF PREFERRED EMBODIMENTS

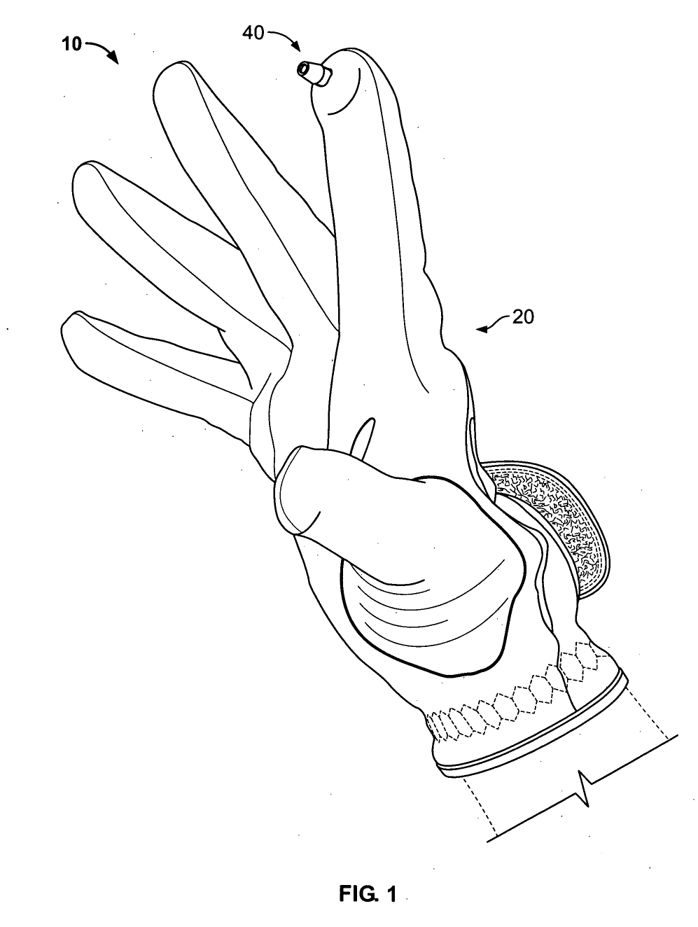

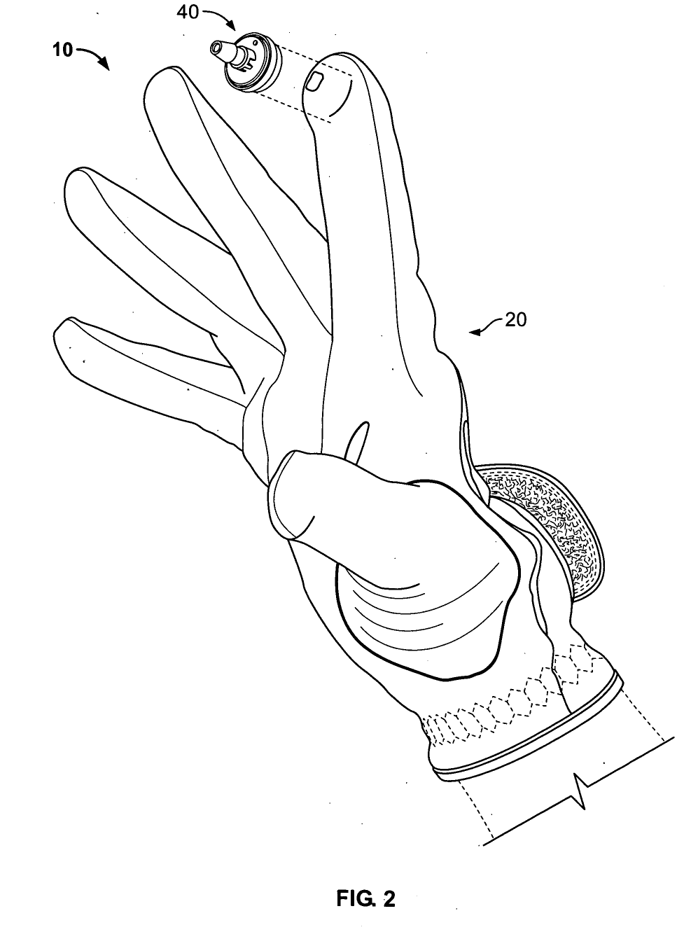

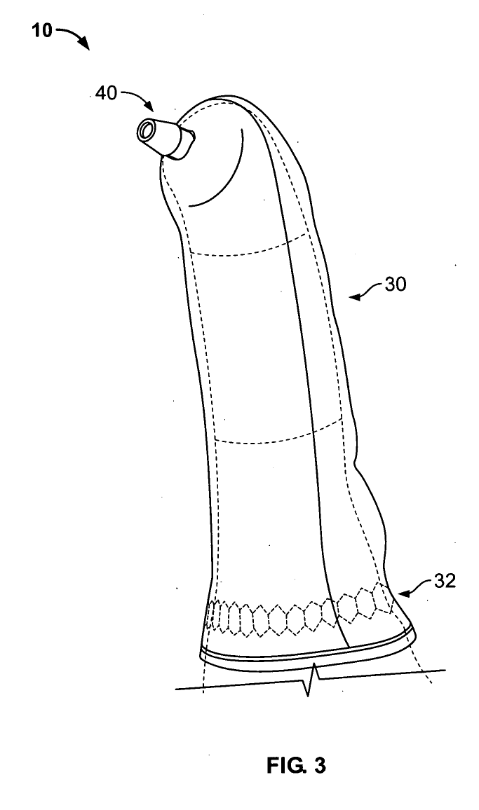

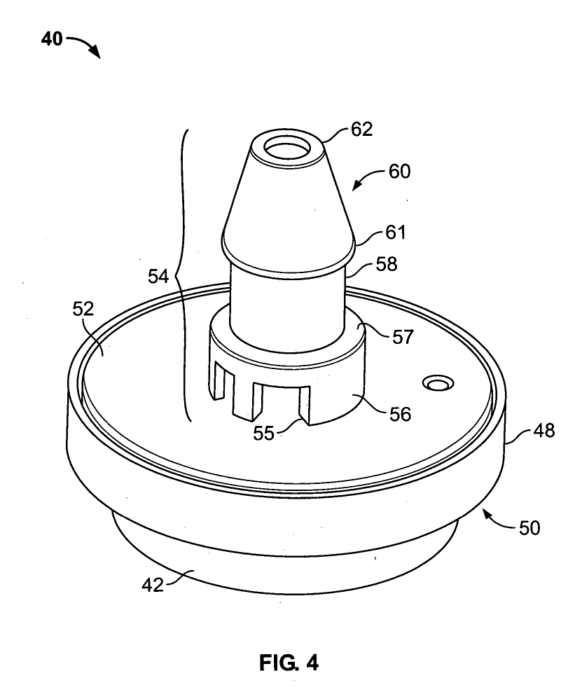

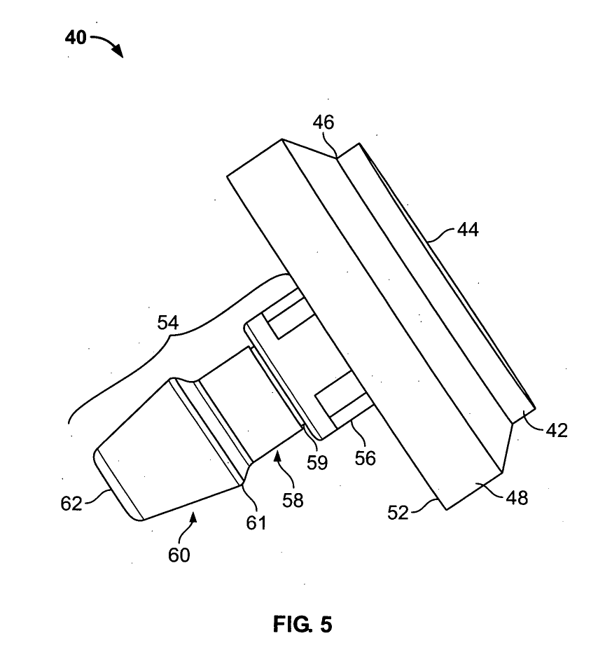

FIGS. 1, 2 and 3 are perspective views depicting two embodiments of the touch screen data control device (10) of the present invention. FIGS. 1 and 2 show an embodiment that includes a hand gloved stylus housing (20). FIG. 3 shows an embodiment that includes a finger sleeved stylus housing (30). FIGS. 4 and 5 are perspective views of the touch screen stylus component (40) of the present invention, which is preferably constructed from rubber or plastic, but may be made from any number of moldable materials suitable for touch screen contact.

FIGS. 1 and 2 depict a first embodiment of the invention, in which touch screen data control device (10) comprises a gloved stylus housing (20) and a stylus component (40), which is attached to stylus housing (20) via conventional glue or a variety of other secure attachment means. Gloved stylus housing (20) may be constructed of any number of materials, including cloth fabrics and fabric blends, leather, cotton, rubber, and the like. Additionally, stylus housing (20) may be constructed with spatially disposed venting hole, operatively positioned seams, and Velcro or other attachment means to optimize both operator comfort and positional stability of gloved stylus housing (20) during use.

FIG. 3 depicts a second embodiment of the invention, in which touch screen data control device (10) comprises a sleeved stylus housing (30) and a stylus component (40), which likewise is attached to stylus housing (30) via glue or other appropriate attachment means. Sleeved stylus housing (30) is constructed with a radially disposed securing attachment (32) distally located from stylus component (40) to fix device (10) in place on an operator's finger when in use. Sleeved stylus housing (30) may be constructed of any number of materials, including cloth fabrics and fabric blends, leather, cotton, rubber, and the like. Additionally, sleeved stylus housing (30) may be constructed with spatially disposed venting hole, operatively positioned seams, and Velcro, elastic or other suitable attachment means to secure sleeved stylus housing (30) in place during use.

Stylus component (40) is designed to be inserted through, and fixedly attached to, a stylus housing such as stylus housing (20), stylus housing (30), or any number of variations thereof. To that end, as shown in FIGS. 4 and 5, stylus component (40) comprises a rounded fingertip base (42), a circumferentially extended base portion (48) and a touch screen contact portion (54). Rounded fingertip base (42) has a concave bottom surface (44) and a top surface (46). An operator's fingertip rests upon concave bottom surface (44) of rounded fingertip base (42) when device (10) is in use.

In order to maximize balance and control of touch screen contact portion (54) in operation, rounded fingertip base (42) is fortified by a circumferentially extended base portion (48) having a bottom surface (50) and a top surface (52), with bottom surface (50).moldably attached and circumferentially extending from top surface (46) of rounded fingertip base (42). Bottom surface (55) of tip support base (56) is moldably attached to and upwardly extends from top surface (52) of circumferentially extended base portion (48). To further facilitate proper balance, control and stability of device (10) when in use, tip support base (56) is moldably attached to circumferentially extended base portion (48) and supports tip extension portion (58), which in turn supports cylindrical tip (60) when engaging a touch screen. In this regard, bottom surface (59) of tip extension portion (58) is moldably attached to and extends upwardly from top surface (57) of tip support base (56). Bottom surface (61) of cylindrical tip (60) is moldably attached atop tip extension portion (58). Top surface (62) of cylindrical tip (60) is in contact with a touch screen when device (10) is in use.

In a preferred embodiment of the present invention, stylus component (40) is inserted within a finger casing of gloved stylus housing (20) or sleeved stylus housing (30) and fixedly stabilized therein with glue or other suitable attachment means. Tip support base (56), circumferentially extended base portion (48) and rounded fingertip base (42) are positioned internally within the finger casing of gloved stylus housing (20) or sleeved stylus housing (30). Tip extension portion (58) and cylindrical tip (60) protrude through an appropriately sized aperture located on the fingertip end of a finger casing on gloved stylus housing (20) or sleeved stylus housing (30). An operator inserts a hand or finger into a chosen stylus housing and engages his or her fingertip with concave bottom surface (44) of rounded fingertip base (42) in order to operatively contact top surface (62) of cylindrical tip (60) with a touch screen to achieve data entry, manipulation and control.

In another preferred embodiment of the present invention (not shown), an operator uses touch screen data control device (10) in conjunction with a second hand glove or finger casing, which is securely attached to an operator's hand opposite device (10). In this embodiment, the second hand glove or finger casing is fixed with an attachment means, such as Velcro, double-sided adhesive tape, or other conventionally available materials, to secure a hand-held electronic data device in place while being manipulated by device (10) positioned on the operator's opposing hand or fingers.

Having thus described the invention, it should be apparent that numerous structural modifications and adaptations may be resorted to without departing from the scope of the instant invention as set forth hereinabove and as defined below by the claims.

I claim:

1. A touch screen data control device comprising:
(a) a stylus housing; and
(b) a stylus component fixedly attached to said stylus housing for engaging an electronic device.

2. The touch screen data control device of claim 1, wherein said stylus component further comprises a touch screen contact portion having a means for controlling data in relation to an electronic device.

3. The touch screen data control device of claim 2, wherein said stylus component further comprises a circumferentially extended base portion fixedly attached to said touch screen contact portion for supporting and stabilizing said touch screen contact portion.

4. The touch screen data control device of claim 3, wherein said stylus component further comprises a rounded fingertip base having a concave bottom surface, which fixedly attaches to said circumferentially extended base portion for operator support and control of said device.

5. The touch screen data control device of claim 1, wherein said stylus housing comprises a hand glove with a finger casing to which said stylus component is fixedly attached.

6. The touch screen data control device of claim 1, wherein said stylus housing comprises a finger sleeve with a finger casing to which said stylus component is fixedly attached.

7. The touch screen data control device of claim 6, wherein said finger sleeve comprises a radially disposed attachment means for securing said finger sleeve during use.
